(19) United States
(12) Patent Application Publication
(10) Pub. No.: US 2021/0045279 A1
(43) Pub. Date: Feb. 18, 2021

(54) TILLAGE SYSTEM WITH VARIABLE FERTILIZER APPLICATION AND TOOL DEPTH ADJUSTMENT

(71) Applicant: CNH Industrial America LLC, New Holland, PA (US)

(72) Inventor: Brian Falasz, Bloomington, IL (US)

(73) Assignee: CNH Industrial America LLC, New Holland, PA (US)

(21) Appl. No.: 16/542,163

(22) Filed: Aug. 15, 2019

(51) Int. Cl. A01B 63/111; A01C 21/00

(52) U.S. Cl. CPC A01B 63/1112; G01S 13/885; A01C 21/007

(57) ABSTRACT

An agricultural implement including a frame, a plurality of ground engaging tools connected to the frame, at least one actuator connected to the frame and configured for controlling a depth of the plurality of ground engaging tools, a fertilizer device configured for applying at least one fertilizer at a variable rate, and an electronic control unit operably connected to the at least one actuator and the fertilizer device. The electronic control unit is configured for automatically adjusting at least one of the depth of the plurality of ground engaging tools dependent upon a compaction layer characteristic and the rate of the fertilizer dependent upon a fertilizer requirement characteristic.

### BACKGROUND OF THE INVENTION

The present invention pertains to agricultural tillage systems and, more specifically, to an electronic control unit for automatically adjusting the application of fertilizer and the depth of the ground engaging tools of the tillage implement.

Farmers utilize a wide variety of tillage systems to prepare soil for planting. For example, a strip tillage implement is capable of tilling soil in strips along the intended planting rows, moving residue to the areas in between rows, and preparing the seedbed of the strip in preparation for planting. As another example, a field cultivator is capable of simultaneously tilling soil and leveling the tilled soil in preparation for planting.

A tillage implement typically includes a frame that carries a number of cultivator shanks which can carry various tools for engaging the soil. The tools may include shovels, knives, points, sweeps, coulters, spikes, or plows. Each tool performs a function intended to ultimately convert compacted soil into a level seedbed with a consistent depth for providing desirable conditions for planting crops. A tillage implement may additionally include, or be connected with, other devices for inserting fertilizer following the passage of the cultivator shanks, closing the furrow created by the cultivator shanks, or breaking up the clods to create the uniform seedbed. For example, the tillage implement may be connected to an air cart which carries and injects fertilizer into the field.

The tillage implement may also include a control system which allows the operator to adjust or more operating parameters of the tillage implement. For example, if the operator wishes to lower the depth of the cultivator shanks, the operator must generally enter a command into the user interface of the control system, and the control system will accordingly adjust the actuator(s) to lower the cultivator shanks. Typically, the operator will set a desired command, such as a speed of the towing vehicle, a specific depth of the cultivator shanks, or the rate of fertilizer, and the control system will maintain the inputted command(s) throughout operation in the entire field. As can be appreciated, a field may not be uniform in soil composition; and thereby, the set and generalized operating parameters of the tillage implement may not provide the ideal operating parameter for certain portions of the field. Therefore, the control system of the tillage implement may lead to excess wear of the tillage implement, increased costs of working a field, and suboptimal planting conditions.

What is needed in the art is a cost-effective tillage system for automatically accommodating various field conditions.

### SUMMARY OF THE INVENTION

In one exemplary embodiment formed in accordance with the present invention, there is provided an agricultural tillage system which generally includes an agricultural vehicle, a fertilizer device, an agricultural tillage implement, and an electronic control unit. The electronic control unit may automatically set and adjust the depth of the agricultural tillage implement, the rate of fertilizer, and/or the type of fertilizer being applied by the fertilizer device, depending upon an estimated or measured compaction layer depth and/or a soil nutrient level.

In another exemplary embodiment formed in accordance with the present invention, there is provided an agricultural implement that includes a frame, a plurality of ground engaging tools connected to the frame, and at least one actuator connected to the frame and configured for controlling a depth of the plurality of ground engaging tools. The agricultural implement also includes a fertilizer device configured for applying at least one fertilizer at a variable rate and comprising a plurality of fertilizer applicators connected to the plurality of ground engaging tools, and an electronic control unit operably connected to the at least one actuator and the fertilizer device. The electronic control unit is configured for automatically adjusting at least one of the depth of the plurality of ground engaging tools dependent upon a compaction layer characteristic and the rate of the fertilizer dependent upon a fertilizer requirement characteristic.

In yet another exemplary embodiment formed in accordance with the present invention, there is provided an agricultural tillage system that includes an agricultural vehicle, a fertilizer device connected to the agricultural vehicle and configured for applying at least one fertilizer at a variable rate and comprising a plurality of fertilizer applicators, and an agricultural implement connected to the fertilizer device. The agricultural implement includes a frame, a plurality of ground engaging tools connected to the frame, and the plurality of fertilizer applicators are connected to the plurality of ground engaging tools, and at least one actuator connected to the frame and configured for controlling a depth of the plurality of ground engaging tools. The agricultural tillage system also includes an electronic control unit operably connected to the at least one actuator and the fertilizer device. The electronic control unit is configured for automatically adjusting at least one of the depth of the plurality of ground engaging tools dependent upon a compaction layer characteristic and the rate of the fertilizer dependent upon a fertilizer requirement characteristic.

In yet another exemplary embodiment formed in accordance with the present invention, there is provided a method for working a field. The method includes an initial step of providing an agricultural implement that includes a frame, a plurality of ground engaging tools connected to the frame, at least one actuator connected to the frame and configured for controlling a depth of the plurality of ground engaging tools, a fertilizer device configured for applying at least one fertilizer at a variable rate and comprising a plurality of fertilizer applicators connected to the plurality of ground engaging tools, and an electronic control unit operably connected to the at least one actuator and the fertilizer device. The method also includes the step of adjusting at least one of: the depth of the plurality of ground engaging tools, by the electronic control unit adjusting the at least one actuator, dependent upon a compaction layer characteristic, and the rate of the fertilizer, by the electronic control unit adjusting the fertilizer device, dependent upon a fertilizer requirement characteristic.

One possible advantage of the exemplary embodiment of the agricultural tillage system is that the depth of the ground engaging tools of the implement as well as the rate and/or type of the fertilizer being applied may be automatically adjusted depending upon compaction layer data and the soil nutrient level at a given location in the field.

Another possible advantage of the exemplary embodiment of the agricultural tillage system is that the overall cost of working a field may be reduced as the electronic control unit helps to decrease wear on the ground engaging tools, by automatically controlling the tools to be at the optimal depth, and optimize the amount of fertilizer being applied to the field.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown Like numerals indicate like elements throughout the drawings. In the drawings:

FIG. 1 illustrates a block diagram of an agricultural tillage system including a agricultural vehicle, a fertilizer device, and an agricultural implement, in accordance with an exemplary embodiment of the present invention;

FIG. 2 illustrates a block diagram of the electronic control unit of the agricultural tillage system of FIG. 1;

FIG. 3 illustrates a fertilizer applicator of the fertilizer device and a ground engaging tool of the agricultural implement of FIG. 1; and

FIG. 4 illustrates a flow diagram of a method for working a field, in accordance with an exemplary embodiment of the present invention.

### DETAILED DESCRIPTION OF THE INVENTION

The terms “forward”, “rearward”, “left” and “right”, when used in connection with the agricultural vehicle and/or components thereof are usually determined with reference to the direction of forward operative travel of the vehicle, but they should not be construed as limiting. The terms “longitudinal” and “transverse” are determined with reference to the fore-and-aft direction of the agricultural vehicle and are equally not to be construed as limiting. The term “compaction layer” generally refers to a compressed layer of soil, beneath the soil surface, which may be less porous or impermeable. As used herein the term “compaction layer characteristic” may refer to the precise or estimated location of the compaction layer, such as the depth of the top of the compaction layer. The term compaction layer characteristic may also refer to any other feature or composition of the compaction layer. Also, as used herein, the term “fertilizer requirement characteristic” may refer a requirement to maintain, increase, or decrease the amount of fertilizer and/or change fertilizers based upon the precise or estimated nutrient level of the soil, the soil composition, and/or any other feature of the soil.

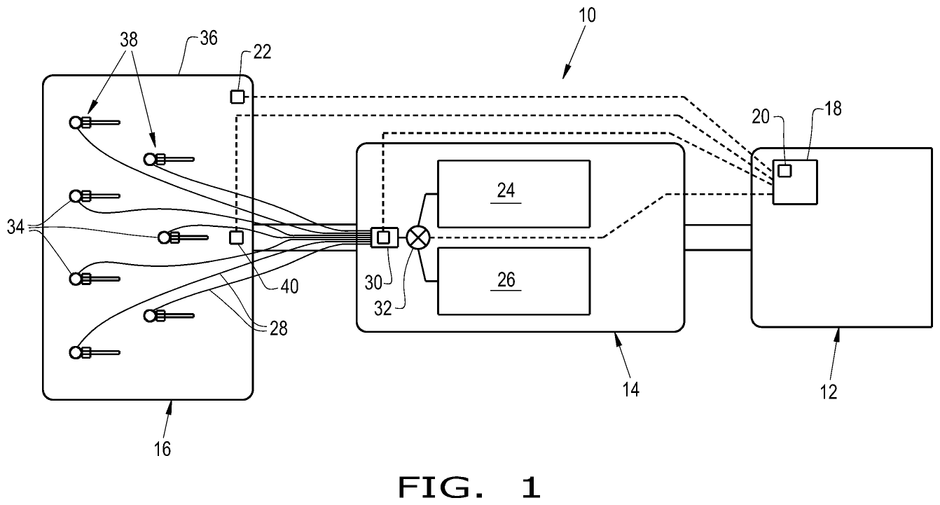

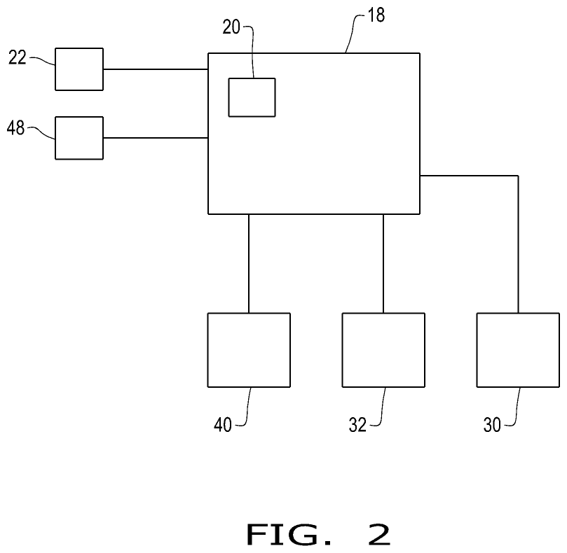

Referring now to the drawings, and more particularly to FIGS. 1-3, there is shown an agricultural tillage system 10 for working a field. The agricultural tillage system 10 generally includes an agricultural vehicle 12 which tows a fertilizer device 14 and an agricultural implement 16. The agricultural tillage system 10 may also include an electronic control unit (ECU) 18, with a memory 20 for storing soil characteristics, and one or more sensors 22 for sensing real-time soil characteristics. The ECU 18 may be configured for automatically adjusting the depth of the agricultural implement 16, the rate of the fertilizer, the type of fertilizer, and/or any other desired parameter depending upon a compaction layer characteristic and/or a fertilizer requirement characteristic. The compaction layer and fertilizer requirement characteristics may be determined from real-time sensor readings and/or estimated from previously measured field data. For instance, the depth of the agricultural implement 16 and the rate of fertilizer may be automatically controlled responsive to various compaction layer depths and soil nutrient levels determined by overlays from a global positioning system (GPS) location, yield maps, field agronomy, and/or real-time sensor readings.

The agricultural vehicle 12 may tow both of the fertilizer device 14 and the agricultural implement 16, with the fertilizer device 14 in front of the agricultural implement 16. The agricultural vehicle 12 may generally include a chassis, a prime mover, wheels and/or tracks, a cab for housing the operator, a hitch, and an ISOBUS connection for coupling with the fertilizer device 14 and/or agricultural implement 16 (not shown). The agricultural vehicle 12 may be in the form of any desired agricultural vehicle, such as a tractor.

The fertilizer device 14 may be connected to the agricultural vehicle 12 and configured for applying at least one fertilizer at a variable rate. The fertilizer device 14 generally includes a frame, at least one storage tank, for example a pair of storage tanks 24, 26, multiple fluid lines 28, a rate controller 30, one or more fertilizer control valves 32, and multiple fertilizer applicators 34. The fertilizer device 14 may be a separate unit or integrated with the agricultural implement 16. For example, the fertilizer device 14 may be in the form of an air cart 14, which is connected in between the agricultural vehicle 12 and the agricultural implement 16. However, the fertilizer device 14 may be in the form of any desired fertilizer device.

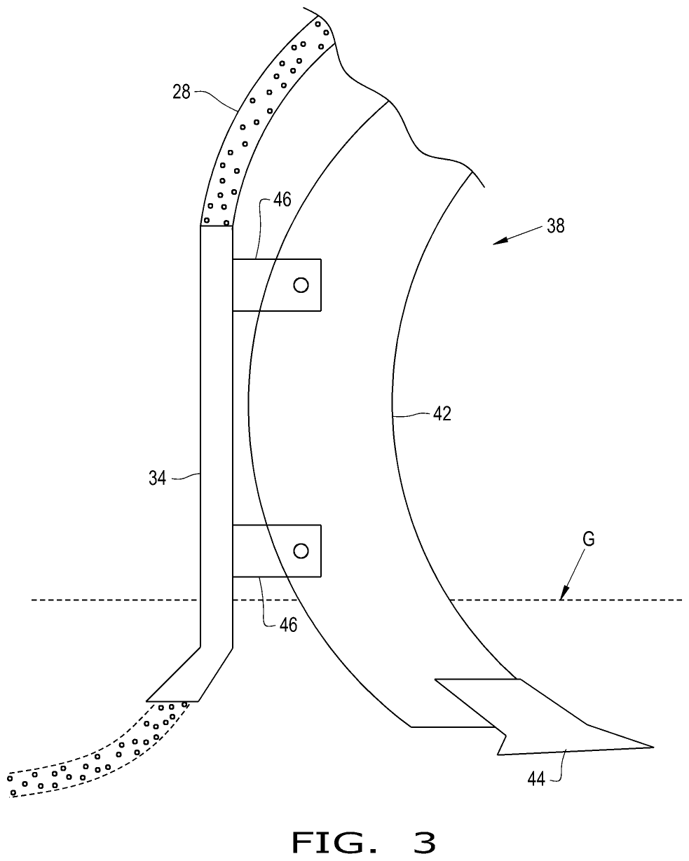

The storage tanks 24, 26 may store a dry, granular or a liquid fertilizer. The same fertilizer may be stored in each tank 24, 26 or a unique fertilizer may be stored in each respective storage tank 24, 26. For instance, the first storage tank 24 may store a first fertilizer and the second storage tank 26 may store a second fertilizer such that the ECU 18 may automatically switch between the two different fertilizers as desired. The fluid lines 28 may be in the form of hoses 28 which extend from the tank(s) 24, 26 to the fertilizer applicators 34. The fluid lines 28 may comprise any desired material, such as rubber. The rate controller 30 may be fluidly connected in between the tank(s) 24, 26 and the fertilizer applicators 34. The rate controller 30 may be in the form of one or more fans and/or adjustable valves. As shown, the rate controller 30 is in the form of a fan 30 for transporting the fertilizer from the tanks 24, 26 to the fertilizer applicators 34. The fan 30 provides a pressure differential, either positive or negative pressure, which then creates an airstream through the fluid lines 28 for transporting the fertilizer. The fertilizer applicators 34 may be in the form of applicator tubes 34 that are connected to and carried by the agricultural implement 16 (FIG. 3).

The agricultural implement 16 may be connected to the fertilizer device 14 or directly to the agricultural vehicle 12. The agricultural implement 16 may generally include a frame 36, wheels, multiple ground engaging tools 38 connected to the frame 36, and at least actuator 40 directly or indirectly connected to the frame 36 (FIGS. 1 and 3). It should be appreciated that the agricultural implement 16 may also incorporate the fertilizer device 14 and/or portions thereof. The agricultural implement 16 may be in the form of any desired implement, such as a field cultivator or sweep. For example, the agricultural implement 16 may be in the form of an Ecolo-Tiger 875 disk ripper, manufactured by Case IH, Inc.

The multiple ground engaging tools 38 may include primary ground engaging tools in the form of shanks 42 with tilling points 44 for working the soil (FIG. 3). The top end of the shanks 42 are connected to the frame 36 and the bottom end of the shanks 42 mount the tilling points 44. The shanks 42 may have an arcuate shape. The shanks 42 and the tilling points 44 may be in the form of any desired shanks and points, respectively. The shanks 42 and tilling points 44 may comprise any desired material, such as metal. As can be appreciated, the ground engaging tools 38 may also include secondary ground engaging tools, such as leveling blades and/or rolling, i.e., crumbler, basket assemblies for finishing the soil. It should be appreciated that the depth of the ground engaging tools 38 may be set to approximately 8-14, plus or minus two inches, and may accordingly be adjusted therefrom. Furthermore, the depth of the ground engaging tools 38 may be set to be an inch underneath the top of the compaction layer.

The applicator tubes 34 may be connected to the rear of the shanks 42 by one or more brackets 46. For instance, the shanks 42 may have pre-drilled holes and the applicator tubes 34 may have the brackets 46 connected thereto with corresponding holes therein such that an operator may removably connect the applicator tubes 34 to the shanks 42 by way of known fasteners. Alternatively, the shanks 42 may include a mounting bracket which removably attaches the applicator tubes 34 thereto (not shown). It should be appreciated that the brackets 46 may be welded and/or fastened onto the shanks 42 and/or applicator tubes 34. It should also be appreciated that the applicator tubes 34 may be connected to the shanks 42 by way of a tongue and grove connection, fasteners, hooks, pins, clamps, and/or straps. Given the direct connection between the shanks 42 and applicator tubes 34, the movement of the shanks 42 simultaneously causes a corresponding movement of the applicator tubes 34. In other words, each applicator tube 34 is located behind a respective shank 42 and automatically moves in conjunction therewith. Hence, the at least one actuator 40 may simultaneously alter the depth underneath the ground G of a respective shank 42, tilling point 44, and applicator tube 34 as a collective unit.

The at least one actuator 40 may be connected to the frame 36. For example, the agricultural implement 16 may include multiple actuators connected in between the frame 26 and the wheels of the agricultural implement 16 for raising or lowering the depth of the ground engaging tools 38. Additionally or alternatively, the agricultural implement 16 may include an actuator 40 connected in between one or more sections of the frame 36. Each actuator 40 may be in the form of any desired actuator, such as a hydraulic cylinder.

The ECU 18 may be operably connected to and/or incorporated within the agricultural vehicle 12, the fertilizer device 14, and/or the agricultural implement 16. The ECU 18 may be operably connected to the rate controller 30, the fertilizer control valves 32 of the fertilizer device 14 to switch between various fertilizers, and the at least one actuator 40. The ECU 18 may include the memory 20, or any other desired tangible computer readable medium, such as a separate remote storage server that is accessible by the ECU 18, for storing data, software code, or instructions. For instance, the memory 20 may store a yield map, which provides crop yield by geographic position, reported form the combine yield data of the previously harvested crop. The memory 20 may store field agronomy data from one or more soil sample measurements, such as prior in-field measurements of the compaction layer, the soil nutrient level, moisture level, remaining residue, and/or any other desired soil parameter. The ECU 18 may compute, e.g. estimate or retrieve from the memory 20, one or more compaction layer characteristics and/or fertilizer requirement characteristics based from the previously measured compaction layer and soil nutrient measurements and/or the real-time sensor readings from a GPS 48 of the agricultural vehicle 12, the compaction layer sensor 22, and yield map data. Thus, the ECU 18 may compute the compaction layer characteristic from GPS location data, yield map data, measured compaction layer data, and/or estimated compaction layer data, as well as the fertilizer requirement characteristic from GPS location data, yield map data, estimated fertilizer data from yield map data, and/or estimated fertilizer data extrapolated from previous in-field soil measurements. Furthermore, the ECU 18 raises or lowers the depth of the agricultural implement 16, increases or decreases the rate of fertilizer, and/or changes the fertilizer being applied in response to the compaction layer and fertilizer requirement characteristics. The ECU 18 may be in the form of any desired ECU or controller. The ECU 18 may be incorporated into the existing software and/or hardware of the agricultural vehicle 12, the fertilizer device 14, and/or the agricultural implement 16. For example, the ECU 18 may be incorporated into the soil command system of the agricultural vehicle 12 and/or implement 16. However, the ECU 18 may be a separate controller which interfaces with the existing soil command system of the agricultural vehicle 12 and/or implement 16.

The one or more sensors 22 may be operably connected to the ECU 18 and mounted on the agricultural implement 16. At least one of the sensors 22 may be in the form of a compaction layer sensor 22 for measuring and communicating measured compaction layer data to the ECU 18, such as a ground penetrating radar sensor 22 for sensing the depth of the compaction layer. Each sensor 22 may accordingly send a feedback signal to the ECU 18, which may then actuate the actuator(s) 40 in responsive to the signal provided by the sensor 22. It should be appreciated that the ground penetrating radar sensor 22 may be connected to the agricultural implement 16 at any desired location, such as in front of the ground engaging tools 38. Alternatively, the sensor 22 may be connected to the fertilizer device 14 or agricultural vehicle 12.

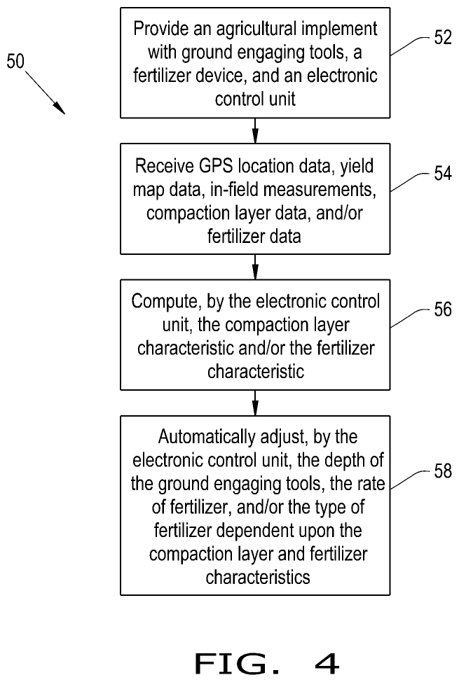

Referring now to FIG. 4, there is shown a flow diagram of a method 50 for working a field. The method may include an initial step of providing an agricultural tillage system 10 which generally includes an agricultural vehicle 12, a fertilizer device 14, an agricultural implement 16, and an ECU 18, as discussed above (at block 52). Next, the ECU 18 may receive real-time data and/or stored data from the memory 20 (at block 54). For example, the ECU 18 may receive GPS location data, yield map data, in-field measurements, estimated and/or measured compaction layer data, and/or estimated and/or measured fertilizer data. The ECU 18 may then compute the compaction layer characteristic and/or the fertilizer requirement characteristic from the received real-time and/or stored data (at block 56). For example, the ECU 18 may estimate the compaction layer characteristic by extrapolating, across the entire field, one or more measured compaction layer depths at one or more locations, having known crop yields. Additionally, for example, the ECU 18 may compute the fertilizer requirement by estimating the soil nutrient level from crop yield from the crop yield map and/or by extrapolating, across the entire field, one or more measured soil nutrient levels at one or more locations in the field, having known crop yields. Then, the ECU 18 may automatically adjust the depth of the plurality of ground engaging tools, the rate of the fertilizer, and/or the type of fertilizer dependent upon a compaction layer characteristic and/or fertilizer requirement characteristic (at block 58). Initially, the ECU 18 may set an initial or starting depth of the ground engaging tools 38 and an initial rate of fertilizer, and then the ECU 18 may automatically raise or lower the ground engaging tools 38 and/or increase or decrease the rate of fertilizer accordingly. For example, in lower yielding areas, the ECU 18 may automatically lower the depth of the ground engaging tools 38, upon estimating or sensing if the compaction layer is deeper, and apply a greater amount of fertilizer, upon estimating a low nutrient level. Additionally, for example, the ECU 18 may automatically switch between one fertilizer to another differing fertilizer, dependent upon the fertilizer requirement characteristic.

It is to be understood that the steps of the method 50 are performed by the controller 18 upon loading and executing software code or instructions which are tangibly stored on a tangible computer readable medium 20, such as on a magnetic medium, e.g., a computer hard drive, an optical medium, e.g., an optical disc, solid-state memory, e.g., flash memory, or other storage media known in the art. Thus, any of the functionality performed by the controller 18 described herein, such as the method 50, is implemented in software code or instructions which are tangibly stored on the tangible computer readable medium 20. The controller 18 loads the software code or instructions via a direct interface with the computer readable medium or via a wired and/or wireless network. Upon loading and executing such software code or instructions by the controller 18, the controller 18 may perform any of the functionality of the controller 18 described herein, including any steps of the method 50 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

In providing the compaction layer characteristic, the ECU 18 may perform any desired calculation and/or retrieve any desired data. For example, the depth of the compaction layer may be determined from global positioning system (GPS) location data, yield map data, measured compaction layer data, and/or estimated compaction layer data. The measured compaction layer characteristic may be determined from real-time compaction layer data, measured by one or more compaction layer sensors 22, and/or prior compaction layer data which was measured from previous in-field compaction layer measurements. The estimated compaction layer characteristic may be determined from extrapolating one or more prior in-field measurements at a given location and averaging the measured result across the entire field in correlation with location and yield map data. Compaction layer depth may be correlated to yield map data. For example, a correlation of whether in-field measurements show that a location with a high crop yield, which was indicated by yield map data, has a certain compaction layer depth and another location with a low crop yield has a differing compaction layer depth may exist. This correlation may be used to subsequently estimate the compaction layer depth in other locations in the field. Furthermore, in providing the fertilizer requirement characteristic, the ECU 18 may also perform any desired calculation and/or retrieve any desired data. For example, the fertilizer requirement characteristic, and the soil nutrient level therewith, may be determined from GPS location data, yield map data, estimated fertilizer data based on yield map data, in-field soil measurements, and/or estimated fertilizer data extrapolated from previous in-field soil measurements. The soil nutrient level may be correlated to the crop yield. For instance, a low yield area may correspond to a low soil nutrient area, which may require additional fertilizer, and a high yield area may correspond to a high soil nutrient area, which may require less fertilizer.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. An agricultural implement, comprising:
a frame;
a plurality of ground engaging tools connected to the frame;
at least one actuator connected to the frame and configured for controlling a depth of the plurality of ground engaging tools;
a fertilizer device configured for applying at least one fertilizer at a variable rate and comprising a plurality of fertilizer applicators connected to the plurality of ground engaging tools; and
an electronic control unit operably connected to the at least one actuator and the fertilizer device, and the electronic control unit is configured for automatically adjusting at least one of the depth of the plurality of ground engaging tools dependent upon a compaction layer characteristic and the rate of the fertilizer dependent upon a fertilizer requirement characteristic.

2. The agricultural implement of claim 1, wherein the plurality of ground engaging tools comprises a plurality of shanks, and each fertilizer applicator is removably connected to a respective shank such that each fertilizer applicator is located behind the respective shank and moves in conjunction with the respective shank.

3. The agricultural implement of claim 2, wherein each fertilizer applicator is in the form of a fertilizer applicator tube.

4. The agricultural implement of claim 1, wherein the compaction layer characteristic is determined from at least one of global positioning system location data, yield map data, measured compaction layer data, and estimated compaction layer data.

5. The agricultural implement of claim 4, further comprising at least one compaction layer sensor connected to the frame, and wherein the measured compaction layer data is at least one of real-time compaction layer data, which is measured by the at least one compaction layer sensor, and prior compaction layer data from previous in-field compaction layer measurements.

6. The agricultural implement of claim 5, wherein the at least one compaction layer sensor is in the form of a ground penetrating radar sensor.

7. The agricultural implement of claim 1, wherein the fertilizer requirement characteristic is determined from at least one of estimated fertilizer data based on yield map data and estimated fertilizer data extrapolated from previous in-field soil measurements.

8. The agricultural implement of claim 1, wherein the fertilizer device is configured for applying a first fertilizer and a second fertilizer which is different than the first fertilizer, and the electronic control unit is additionally configured for automatically switching between the first fertilizer and the second fertilizer dependent upon the fertilizer requirement characteristic.

9. An agricultural tillage system, comprising:
an agricultural vehicle;
a fertilizer device connected to the agricultural vehicle and configured for applying at least one fertilizer at a variable rate and comprising a plurality of fertilizer applicators;
an agricultural implement connected to the fertilizer device, comprising:
a frame;
a plurality of ground engaging tools connected to the frame, and the plurality of fertilizer applicators are connected to the plurality of ground engaging tools; and
at least one actuator connected to the frame and configured for controlling a depth of the plurality of ground engaging tools; and
an electronic control unit operably connected to the at least one actuator and the fertilizer device, and the electronic control unit is configured for automatically adjusting at least one of the depth of the plurality of ground engaging tools dependent upon a compaction layer characteristic and the rate of the fertilizer dependent upon a fertilizer requirement characteristic.

10. The agricultural tillage system of claim 9, wherein the plurality of ground engaging tools comprises a plurality of shanks, and each fertilizer applicator is removably connected to a respective shank such that each fertilizer applicator is located behind the respective shank and moves in conjunction with the respective shank.

11. The agricultural tillage system of claim 10, wherein each fertilizer applicator is in the form of a fertilizer applicator tube.

12. The agricultural tillage system of claim 9, wherein the compaction layer characteristic is determined from at least one of global positioning system location data, yield map data, measured compaction layer data, and estimated compaction layer data.

13. The agricultural tillage system of claim 12, further comprising at least one compaction layer sensor connected to the frame, and wherein the measured compaction layer data is at least one of real-time compaction layer data, which is measured by the at least one compaction layer sensor, and prior compaction layer data from previous in-field compaction layer measurements.

14. The agricultural tillage system of claim 13, wherein the at least one compaction layer sensor is in the form of a ground penetrating radar sensor.

15. The agricultural tillage system of claim 9, wherein the fertilizer requirement characteristic is determined from at least one of estimated fertilizer data based on yield map data and estimated fertilizer data extrapolated from previous in-field soil measurements.

16. The agricultural tillage system of claim 9, wherein the fertilizer device is configured for applying a first fertilizer and a second fertilizer which is different than the first fertilizer, and the electronic control unit is additionally configured for automatically switching between the first fertilizer and the second fertilizer dependent upon the fertilizer requirement characteristic.

17. A method for working a field, comprising:
providing an agricultural implement comprising a frame, a plurality of ground engaging tools connected to the frame, at least one actuator connected to the frame and configured for controlling a depth of the plurality of ground engaging tools, a fertilizer device configured for applying at least one fertilizer at a variable rate and comprising a plurality of fertilizer applicators connected to the plurality of ground engaging tools, and an electronic control unit operably connected to the at least one actuator and the fertilizer device; and
adjusting at least one of:
the depth of the plurality of ground engaging tools, by the electronic control unit adjusting the at least one actuator, dependent upon a compaction layer characteristic; and
the rate of the fertilizer, by the electronic control unit adjusting the fertilizer device, dependent upon a fertilizer requirement characteristic.

18. The method of claim 17, further including a step of computing, by the electronic control unit, the compaction layer characteristic from at least one of global positioning system location data, yield map data, measured compaction layer data, and estimated compaction layer data, and the fertilizer requirement characteristic from at least one of estimated fertilizer data based on yield map data and estimated fertilizer data extrapolated from previous in-field soil measurements.

19. The method of claim 18, wherein the agricultural implement further comprises at least one compaction layer sensor connected to the frame, and wherein the measured compaction layer data is at least one of real-time compaction layer data, which is measured by the at least one compaction layer sensor, and prior compaction layer data from previous in-field compaction layer measurements.

20. The method of claim 17, wherein the fertilizer device is configured for applying a first fertilizer and a second fertilizer which is different than the first fertilizer, and the method further comprises a step of automatically switching between the first fertilizer and the second fertilizer, by the electronic control unit, dependent upon the fertilizer requirement characteristic.
